(19) United States
(12) Patent Application Publication
(10) Pub. No.: US 2013/0128383 A1
(43) Pub. Date: May 23, 2013

(54) ELECTRONIC DEVICE HAVING INDICATION CIRCUIT FOR DATA TRANSMISSION RATE OF HARD DISK DRIVES

(71) Applicants: KANG WU, Shenzhen City (CN); BO TIAN, Shenzhen City (CN)

(72) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/449,300

(22) Filed: Apr. 17, 2012

(30) Foreign Application Priority Data
Nov. 22, 2011 (CN) 201110373447.X

(51) Int. Cl. G11B 20/00

(52) U.S. Cl. 360/79; G9B/20

(57) ABSTRACT

An indication circuit includes a platform controller hub (PCH), a hard disk drive detector, an indication circuit, and a control circuit. The indication circuit includes a plurality of light-emitting diodes (LEDs). The PCH outputs indication signals to indicate data transmission rates of hard disk drives of an electronic device. The hard disk drive detector outputs present signals to confirm the presence of each of the hard disk drives upon connection of the hard disk drives to the hard disk drive backplane. The control circuit outputs voltage signals to turn on/off the LEDs, according to the indication signals and the present signals.

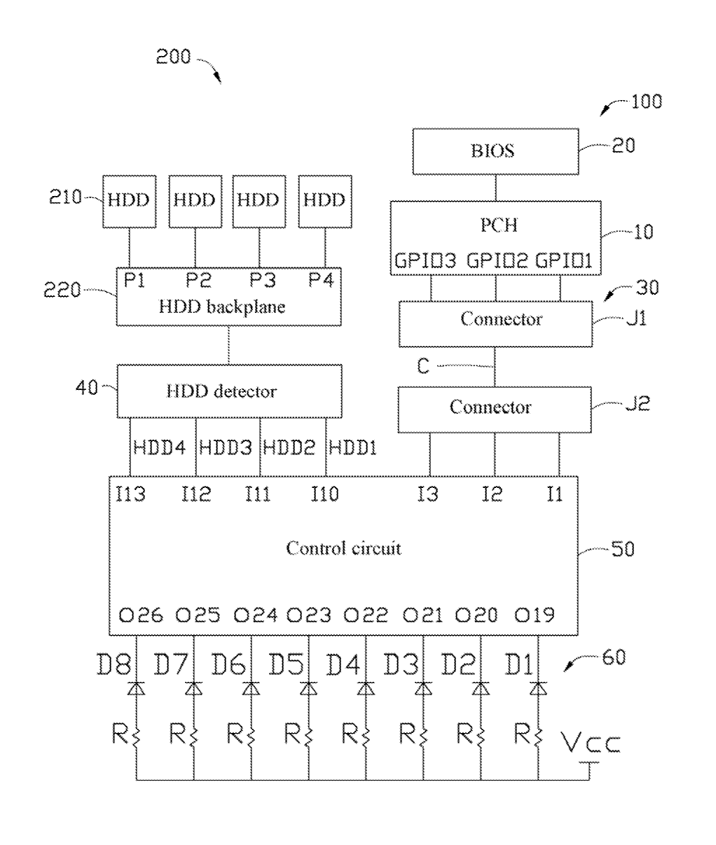

### BACKGROUND

1. Technical Field

The disclosure generally relates to indication circuits, particularly relates to an indication circuit for indicating data transmission rates of hard disk drives.

2. Description of the Related Art

A number of hard disk drives are present in electronic devices such as servers. Since different hard disk drives have different data transmission rates, for example, the date transmission rates of a first generation hard disk drive, of a second generation hard disk drive, and of a third generation hard disk drive are respectively 1.5 Gbps, 3.0 Gbps, 6.0 Gbps. However, users cannot directly get the data transmission rates of the hard disk drives, and the inability of the electronic devices to show the date transmission rates of the hard disk drives is a significant disadvantage.

Therefore, there is room for improvement within the art.

### BRIEF DESCRIPTION OF THE DRAWINGS

Many aspects of a circuit for indicating data transmission rates of hard disk drives can be better understood with reference to the drawing. The components in the drawing are not necessarily drawn to scale, the emphasis instead being placed upon clearly illustrating the principles of the disclosure.

The FIGURE shows an indication circuit, which can be used in an electronic device that shows data transmission rates of hard disk drives of the electronic device.

### DETAILED DESCRIPTION

The FIGURE shows an indication circuit 100, which can be used in an electronic device 200 that shows data transmission rates of hard disk drives 210 of the electronic device 200. The electronic device can be a server, for example.

The electronic device 200 further includes a hard disk drive backplane 220, and in one exemplary embodiment, the hard disk drive backplane 220 includes four connection ports P1, P2, P3, and P4, for connecting four hard disk drives 210. The data transmission rates of the four hard disk drives 210 are the same in order to maintain smooth operation of the electronic device 200. For example, all the data transmission rates of the four hard disk drives 210 can be one of 1.5 Gbps, 3.0 Gbps, or 6.0 Gbps.

The indication circuit 100 includes a platform controller hub (PCH) 10, a basic input/output system (BIOS) 20, a connection assembly 30, a hard disk drive detector 40, a control circuit 50, and an indication unit 60.

The PCH 10 includes three general purpose input/output (GPIO) ports, which are respectively labeled GPIO1, GPIO2, and GPIO3.

The BIOS 20 presets the data transmission rate of the four hard disk drives 210. For example, manufacturers can configure the BIOS 20 to tell the hard disk drives 210 to run at 3.0 GBps when the hard disk drives 210 having the data transmission rate of 3.0 Gbps are connected to the hard disk drive backplane 220. Additionally, the BIOS 20 is electronically connected to the PCH 10 and controls the GPIO1, GPIO2, and GPIO3 ports to output indication signals according to the preset data transmission rate. The indication signals may be digital signals such as logic “0” or “1”. For example, when the preset data transmission rate is 1.5 Gbps, the BIOS 20 controls the GPIO1 port to output logic “0”, and controls both the GPIO2 and GPIO3 ports to output logic “1”. When the preset data transmission rate is 3.0 Gbps, the BIOS 20 controls the GPIO2 port to output logic “0”, and controls both the GPIO1 and GPIO3 ports to output logic “1”. When the preset data transmission rate is 6.0 Gbps, the BIOS 20 controls the GPIO3 port to output logic “0”, and controls both the GPIO1 and GPIO2 ports to output logic “1”.

The connection assembly 30 includes connectors J1, J2, and a cable C. The connector J1 is electronically connected to the GPIO1, GPIO2, and GPIO3 ports, the connector J2 is electronically connected to control circuit 50, and the cable C is electronically connected between the connectors J1 and J2. Thus, the indication signals output from the PCH 10 can be transmitted to the control circuit 50 via the connection assembly 30.

The hard disk drive detector 40 detects whether the hard disk drive 210 is connected to the hard disk drive backplane 220, and outputs signals HDD1, HDD2, HDD3, or HDD4 (present signals) to confirm the respective connected status of each of the four hard disk drives 210 in relation to the connection ports P1, P2, P3, or P4. The present signals HDD1, HDD2, HDD3, and HDD4 may be digital signals such as logic “0” or “1”, or analog voltage signals of 3V or 5V. For example, when the hard disk drive 210 is connected to the hard disk drive backplane 220 via the connection port P1, the hard disk drive detector 40 will output the present signal HDD1.

The control circuit 50 includes input pins I1-I3, I10-I13, and output pins O19-O26. The input pins I1-I3 are electronically connected to the connector J2 to receive the indication signals output from the PCH 10. The input pins I10-I13 are electronically connected to the hard disk drive detector 40 to receive the present signals. The control circuit 50 outputs voltage signals via the output pins O19-O26 according to the indication signals and the present signals, for controlling the indication unit 60. The voltage signals may be a low voltage signal of 3V, a high voltage signal of 5V, or a pulsed signal. When the control circuit 50 receives the present signal HDD1 and the indication signal of logic “0” output from the GPIO1 port, the output pin O19 outputs the low voltage signal. When the control circuit 50 receives the present signal HDD1 and the indication signal of logic “0” output from the GPIO2 port, the output pin O20 outputs the low voltage signal. When the control circuit 50 receives the present signal HDD1 and the indication signal of logic “0” output from the GPIO3 port, the output pin O20 outputs the pulsed signal. The logical relationships between the above-described signals are summarized in the following table.

| | Present signals | | | |
|---|---|---|---|---|
| | Present | Present | Present | Present |
| Indication | signal | signal | signal | signal |
| signals | HDD1 | HDD2 | HDD3 | HDD4 |
| Indication | Low voltage | Low voltage | Low voltage | Low voltage |
| signal of | signal output | signal output | signal output | signal output |
| logic “0” | from O19 | from O21 | from O23 | from O25 |
| output from | | | | |
| the GPIO1 port | | | | |
| Indication | Low voltage | Low voltage | Low voltage | Low voltage |
| signal of | signal output | signal output | signal output | signal output |
| logic “0” | from O20 | from O22 | from O24 | from O26 |
| output from | | | | |
| the GPIO2 port | | | | |
| Indication | Pulsed signal | Pulsed signal | Pulsed signal | Pulsed signal |
| signal of | output from | output from | output from | output from |
| logic “0” | O20 | O22 | O24 | O26 |
| output from | | | | |
| the GPIO3 port | | | | |

The indication unit 60 includes a number of light-emitting diodes (LEDs) that indicate the data transmission rate(s) of the hard disk drive 210. In one exemplary embodiment, the number of the LEDs is eight, and are respectively labeled as D1, D2, D3, D4, D5, D6, D7, and D8. Anodes of the D1, D2, D3, D4, D5, D6, D7, and D8 LEDs are connected to a power supply VCC (about 5V) via a resistor R. Cathodes of the D1, D2, D3, D4, D5, D6, D7, and D8 LEDs are respectively connected to the output pins O19-O26. Thus, the D1, D3, D5, and D7 LEDs will be turned on when they receive the low voltage signal (e.g., 3V) output from the output pins O19, O21, O23, O25. The D2, D4, D6, and D8 LEDs will be turned on when they receive the low voltage signal (e.g., 3V) output from the output pins O20, O22, O24, O26. The D2, D4, D6, and D8 will twinkle or flash when they receive the pulsed signal output from the output pins O20, O22, O24, O26.

When only three hard disk drives 210 having the data transmission rate of 3.0 Gbps are respectively connected to the connection ports P1, P2, P3, a manufacturer presets the data transmission rate of 3.0 Gbps through the BIOS 20. Then, the hard disk drive detector 40 outputs present signals HDD1, HDD2, HDD3, and the BIOS 20 controls the GPIO2 port to output a indication signal of logic “0”. The control circuit receives the present signals HDD1, HDD2, HDD3, and the indication signal of logic “0”, and then the output pins O20, O22, O24 all output the low voltage signal (e.g., 3V) to the indication unit 60 to turn on the D2, D4, and D6 LEDs. Thus, users can directly know the hard disk drives 210 which are connected to the connection ports P1, P2, P3, and that the data transmission rate of all the hard disk drives 210 is 3.0 Gbps.

The hard disk drive detector 40 outputs present signals when it detects one or more of the hard disk drives 210, and the BIOS 20 controls the PCH to output indication signals. Then, the control circuit 50 outputs voltage signals to turn on/off the indication unit 60, according to the present signals and the indication signal. Thus, users can directly know the date transmission rate(s) of the hard disk drives 210 by means of the indication unit 60. The indication circuit 100 is convenient and efficient and automatic.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of the exemplary disclosure to the full extent indicated by the broad general meaning of the terms in which the appended claims are expressed.

What is claimed is:

1. An indication circuit for an electronic device that comprises a hard disk drive backplane and hard disk drives, the indication circuit comprising:
a platform controller hub (PCH);
a hard disk drive detector electronically connected the hard disk drive backplane;
an indication circuit comprising a plurality of light-emitting diodes (LEDs); and
a control circuit electronically connected to the PCH, the hard disk drive detector, and the plurality of LEDs;
wherein the PCH outputs indication signals indicating data transmission rates of the hard disk drives;
and wherein upon connection of the hard disk drives to the hard disk backplane, the hard disk drive detector outputs present signals and the control circuit outputs voltage signals to turn on/off the plurality of LEDs, according to the indication signals and the present signals.

2. The indication circuit as claimed in claim 1, further comprising a basic input/output system (BIOS) electronically connected to the PCH, wherein the BIOS presets the data transmission rates, and controls the PCH to output the indication signals according to the preset data transmission rates.

3. The indication circuit as claimed in claim 2, wherein the PCH includes three general purpose input/output (GPIO) ports that output the indication signals.

4. The indication circuit as claimed in claim 3, wherein the BIOS controls one of the three GPIO ports to output the indication signal of logic “0”, and controls the other two GPIO ports to output the indication signals of logic “1”.

5. The indication circuit as claimed in claim 1, further comprising a connection assembly connected between the PCH and the control circuit, wherein the indication signals are transmitted to the control circuit via the connection assembly.

6. The indication circuit as claimed in claim 5, wherein the connection assembly includes two connectors and a cable, one connector is electronically connected to the PCH, the other one connector is electronically connected to the control circuit, and the cable is electronically connected between the two connectors.

7. The indication circuit as claimed in claim 1, wherein the control circuit includes a plurality of output pins, each output pin is connected to one LED to output the voltage signal to the LED.

8. An indication circuit for an electronic device that comprising a hard disk drive backplane and hard disk drives, the indication circuit comprising:
a basic input/output system (BIOS);
a platform controller hub (PCH) electronically connected to the BIOS;
a hard disk drive detector electronically connected the hard disk drive backplane;
an indication circuit; and
a control circuit electronically connected to the PCH, the hard disk drive detector, and the indication circuit;
wherein the BIOS presets data transmission rates of the hard disk drives, and controls the PCH to output indication signals according to the data transmission rates, the hard disk drive detector outputs present signals to confirm the presence of each of the hard disk drives upon connection of the hard disk drives to the hard disk drive backplane, the control circuit outputs voltage signals to enable/disable the indication circuit, according to the indication signals and the present signals.

9. The indication circuit as claimed in claim 8, wherein the PCH includes three general purpose input/output (GPIO) ports that output the indication signals.

10. The indication circuit as claimed in claim 9, wherein the BIOS controls one of the three GPIO ports to output the indication signal of logic “0”, and controls the other two GPIO ports to output the indication signals of logic “1”.

11. The indication circuit as claimed in claim 1, wherein the control circuit includes a plurality of output pins, and the indication circuit further includes a plurality of light-emitting diodes (LEDs), each output pin is connected to one of the LEDs to output the voltage signal to the LED to turn on/off the LED.

12. An electronic device comprising a hard disk drive backplane, hard disk drives, and an indication circuit, the indication circuit comprising:
a platform controller hub (PCH);
a hard disk drive detector electronically connected the hard disk drive backplane;
an indication circuit comprising a plurality of light-emitting diodes (LEDs); and
a control circuit electronically connected to the PCH, the hard disk drive detector, and the plurality of LEDs;
wherein the PCH outputs indication signals indicating data transmission rates of the hard disk drives, the hard disk drive detector outputs present signals to confirm the presence of each of the hard disk drives upon connection of the hard disk drives to the hard disk drive backplane, the control circuit outputs voltage signals to turn on/off the plurality of LEDs, according to the indication signals and the present signals.

13. The electronic device as claimed in claim 12, wherein the indication circuit further comprising a basic input/output system (BIOS) electronically connected to the PCH, the BIOS presets the data transmission rates, and controls the PCH to output the indication signals according to the preset data transmission rates.
